(19) United States
(12) Patent Application Publication
(10) Pub. No.: US 2012/0100835 A1
(43) Pub. Date: Apr. 26, 2012

(54) SYSTEM AND METHOD FOR READING SMS MESSAGES

(75) Inventor: JUN LI, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/167,712

(22) Filed: Jun. 24, 2011

(30) Foreign Application Priority Data
Oct. 21, 2010 (CN) 201010514519.3

(51) Int. Cl. H04W 4/14

(52) U.S. Cl. 455/412.1

(57) ABSTRACT

A method for reading Short Message Service (SMS) messages using a mobile device, a user can read the SMS messages saved in a mailbox of the mobile device by acquiring a contact entry. The user selects the contact entry in a contact list saved in a memory of the mobile device. Then, the mobile device reads a phone number of the contact entry. Continually, the mobile device acquires the SMS messages from the memory, and reads identifier numbers and the phone numbers of the SMS messages. After comparing procedure, if a phone number of one of SMS messages is the same as the phone number of the contact entry, the mobile device saves an identifier number corresponding to the one of SMS messages to the memory. The mobile device loads the SMS messages corresponding to the identifier numbers saved in the memory into the mailbox.

### BACKGROUND

1. Technical Field

Embodiments of the present disclosure relate to reading messages in the Short Message Service (SMS), and more particularly to a method for reading SMS messages according to SMS senders and a system thereof.

2. Description of Related Art

SMS is currently one of the most widely used forms of mobile communication. Most mobile devices have the ability to both send and receive messages through the SMS. However, after using the SMS for a time, many messages are saved in the mobile devices. It is not easily to find specific messages from the mailbox of the SMS. What is needed, therefore, is a method for reading the SMS messages using the mobile devices to overcome the limitations described.

### BRIEF DESCRIPTION OF THE DRAWINGS

FIG. 1 is a block diagram of one embodiment of a mobile device.

FIG. 2 is a block diagram of one embodiment of a system for reading SMS messages using the mobile device of FIG. 1.

FIG. 3 is a flowchart of one embodiment of a method for reading SMS messages using a mobile device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

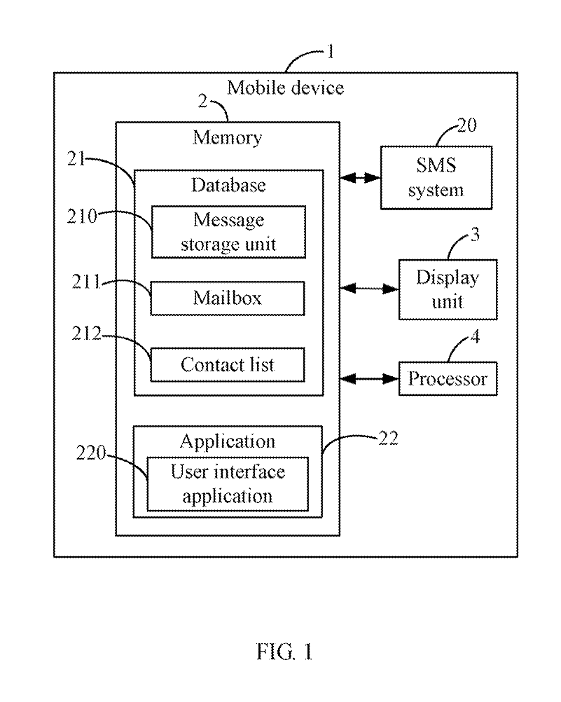

FIG. 1 is a block diagram of one embodiment of a mobile device 1. Depending on the embodiment, the mobile device 1 may be a mobile phone, a personal digital assistant (PDA), a handheld game console, a digital camera, a handheld computer, or other electronic device. The mobile device 1 includes a memory 2, a display unit 3, at least one processor 4, and a Short Message Service (SMS) system 20 including an acquiring module 201, a reading module 202, a comparison module 203, a recording module 204, a determination module 205, and a loading module 206. The memory 2 saves a database 21 and applications 22.

The mobile device 1 is generally controlled and coordinated by an operating system software, such as UNIX, LINUX, WINDOWS, MAC OS X, an embedded operating system, or any other compatible operating systems. In other embodiments, the mobile device 1 may be controlled by a proprietary operating system. Conventional operating systems control and schedule computer processes for execution, perform memory management, provide file system, networking, and I/O services, and provide a user interface, such as a graphical user interface (GUI), among other things.

The memory 2 is electronically connected to the display unit 3, the at least one processor 4 and the SMS system 20. The memory 2 is operable to save many kinds of data, such as the database 21, the applications 22 and customization function codes of the mobile device 1, computerized codes of the SMS system 20, programs of an operating system and other applications of the mobile device 1. The memory 2 may include a hard disk drive, flash memory, RAM, ROM, cache, or external storage mediums.

The database 21 includes a message storage unit 210, a mailbox 211 and a contact list 212. The message storage unit 210 is operable to save SMS messages received. The SMS messages include identifier numbers respectively. The identifier numbers are unique for each SMS message and are used for identifying different SMS messages. The information of the SMS messages includes message content, phone numbers of a phone or device which sent the SMS messages and a sender's name of the SMS messages. The SMS messages are saved in the message storage unit 210 of the memory 2 in a specific order.

In one embodiment, the specific order of the SMS messages is alphabetical, depending on the first letters of titles of the SMS messages. For example, the SMS messages are arranged in an ascending alphabetical order of the first letters of SMS messages. In other embodiments, the specific order is depending on received time of the SMS messages. For more examples, the SMS messages can be arranged in the ascending order of the received time of SMS messages.

The mailbox 211 is operable to save the SMS messages wanted to be read by a user. In one embodiment, the mailbox 211 can load all the SMS messages from the message storage unit 210 when the mailbox is executed/opened. The user can enter the mailbox 211 to read the SMS messages received. In other embodiments, if the user wants to read SMS messages relative to a specific sender, the SMS system 20 can load the SMS messages received from the specific sender from the message storage unit 210 into the mailbox 211. The detail of the procedure of the SMS system 20 is disclosed thereafter.

The contact list 212 is operable to save information of contacts. For example, the information of the contacts includes phone numbers, contact names or addresses of the contacts.

The applications 22 are operable to execute different functions in the mobile device 1. In one embodiment, one of the applications 22 can be a user interface application operated in the contact list 212. The user interface application can provide the user different user interfaces to access the contact list 212. For example, the user interface application provides that the user input a contact entry by the touch screen or an input unit of the mobile device 1, such as a keypad. Then, the contact corresponding to the contact entry is displayed on the display unit 3. In other embodiments, the other applications 22 can be the user interface application operated in the mailbox 211. The user interface application can display the SMS messages corresponding to the contact entry in the mailbox 211.

The display unit 3 displays information related to the SMS messages saved in the mobile device 1. The display unit 3 can be a display screen, a resistive touch screen, or a capacitive touch screen.

The modules 201-206 may comprise computerized code in the form of one or more programs that are saved in the memory 2. The computerized code includes instructions that are executed by the at least one processor 4 to provide functions for modules 201-206. The at least one processor 4, as an example, may include a CPU, math coprocessor, shift register.

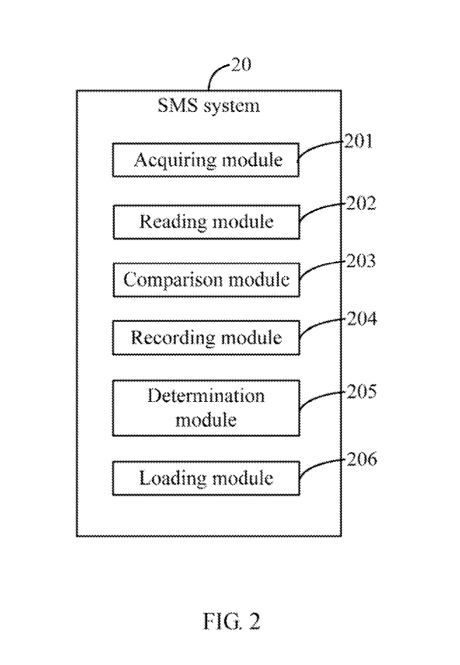

As shown in FIG. 2, a block diagram of one embodiment of the SMS system 20 for reading the SMS messages using the mobile device 1 is shown. The SMS system 20 can allow the user to read the SMS messages saved in the mailbox 211 of the mobile device 1 by acquiring the contact entry.

The acquiring module 201 is operable to acquire the contact entry input by the user in the contact list 212 from the database 21 of the memory 2. In one embodiment, if the contact entry input by the user is not saved in the contact list 212, the acquiring module 201 can directly acquire the phone number input from the user (input from a keyboard and/or touchscreen) to the reading module 202. In addition, the acquiring module 201 acquires the SMS messages from the message storage unit 210 of the memory 2.

The reading module 202 is operable to read the phone number of the contact entry. In addition, the reading module 202 reads the identifier numbers and the phone numbers of the SMS messages saved in the message storage unit 210 of the memory 2.

The comparison module 203 is operable to determine whether a phone number of one of SMS messages is the same as the phone number of the contact entry. If the phone number of the one of SMS messages is the same as the phone number of the contact entry, the one of SMS messages is determined sent by the contact checked by the user.

The recording module 204 is operable to save the identifier number of the one of SMS messages to the memory 2 if the phone number of the one of SMS messages is the same as the phone number of the contact entry.

The determination module 205 is operable to determine whether all the SMS messages saved in the message storing unit 210 are compared by the comparison module 203. If all the SMS messages are not compared by the comparison module 203, the comparison module 203 continually executes the comparison process that determines whether a phone number of one of SMS messages is the same as the phone number of the contact entry. If all the SMS messages are compared by the comparison module 203, the determination module 205 sends a signal to the comparison module 203 to end the comparison process.

The loading module 206 is operable to load the SMS messages corresponding to the identifier numbers saved in the memory 2 into the mailbox 211. In addition, the loading module 206 cleans information in the mailbox 211 when the SMS system 20 is started to be executed.

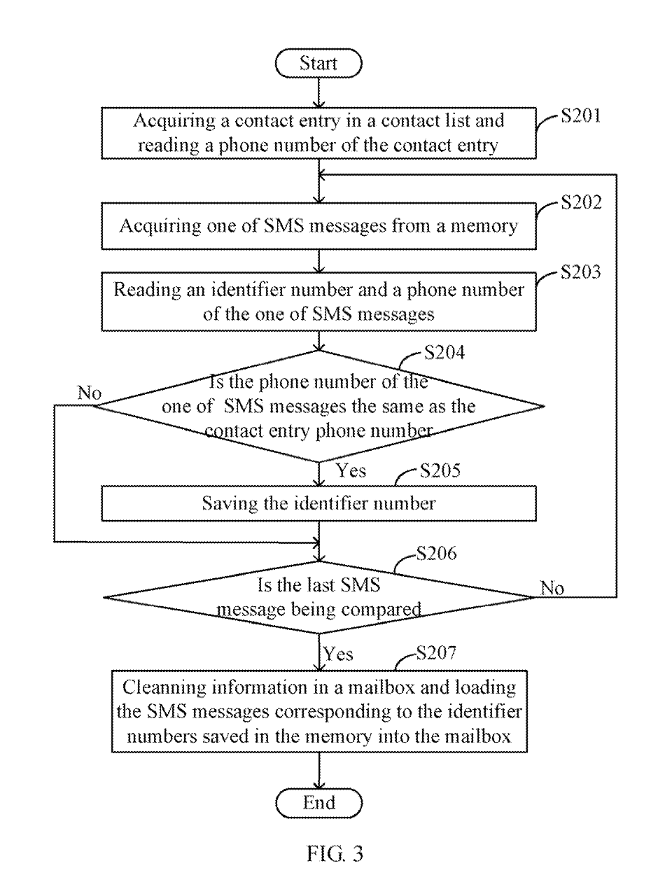

FIG. 3 is a flowchart of one embodiment of a method for reading SMS messages using a mobile device 1. Depending on the embodiment, additional blocks may be added, others deleted, and the ordering of the blocks may be changed.

In block S201, the acquiring module 201 acquires a contact entry input by the user in a contact list 212 from the database 21 of the memory 2, and the reading module 202 reads a phone number of the contact entry.

In block S202, the acquiring module 201 acquires one of SMS messages from the message storage unit 210 of the memory 2.

In block S203, the reading module 202 reads an identifier number and a phone number of the one of SMS messages.

In block S204, the comparison module 203 determines whether the phone number of the one of SMS messages is the same as the phone number of the contact entry.

If the phone number of the one of SMS messages is not the same as the phone number of the contact entry, block S206 is implemented. If the phone number of the one of SMS messages is the same as the phone number of the contact entry, block S205 is implemented.

In block S205, the recording module 204 saves the identifier number of the one of SMS messages to the memory 2.

In block S206, the determination module 205 determines whether all the SMS messages are compared by the comparison module 203. In one embodiment, the determination module 205 determines whether the one of SMS message is the last SMS message being compared. If the one of SMS message is the last SMS message being compared, block S207 is implemented. If the one of SMS message is not the last SMS message being compared, the determination module 205 determines that the SMS system 20 continues the process in the SMS messages saved in the message storing unit 210 and returns to block 202.

In block S207, the loading module 206 loads the SMS messages corresponding to the identifier numbers saved in the memory 2 into the mailbox 211. In addition, the loading module 206 cleans information saved in the mailbox 211 when the SMS system 20 is started to be executed.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile device, comprising:
a memory including a mailbox for saving Short Message Service (SMS) messages;
at least one processor;
one or more programs that are stored in the memory and are executed by the at least one processor, the one or more programs comprising:
an acquiring module operable to acquire a contact entry input by a user in a contact list of the memory and the SMS messages from the memory;
a reading module operable to read a phone number of the contact entry, identifier numbers and the phone numbers of the SMS messages saved in the memory;
a comparison module operable to determine whether a phone number of one of SMS messages is the same as the phone number of the contact entry;
a recording module operable to save the identifier number of the one of SMS messages to the memory if the phone number of the one of SMS messages is the same as the phone number of the contact entry;
a determination module operable to determine whether all the SMS messages are compared; and
a loading module operable to load the SMS messages corresponding to the identifier numbers saved in the memory into the mailbox when all the SMS messages are compared.

2. The mobile device of claim 1, wherein the loading module cleans information in the mailbox before loading the SMS messages corresponding to the identifier numbers saved in the memory into the mailbox.

3. The mobile device of claim 1, wherein the SMS messages are saved in the memory in a specific order.

4. The mobile device of claim 3, the specific order is depending on the first letters of titles of the SMS messages.

5. The mobile device of claim 3, wherein the identifier numbers are unique for each SMS message.

6. A method for reading Short Message Service (SMS) messages using a mobile device, the mobile device comprising a memory and at least one processor, the memory including a mailbox for saving the SMS messages, the method comprising:
acquiring a contact entry input by a user in a contact list of the memory and reading a phone number of the contact entry;
acquiring one of SMS messages from the memory;
reading an identifier number and a phone number of the one of SMS messages;
determining whether the phone number of the one of SMS messages is the same as the phone number of the contact entry;
saving the identifier number of the one of SMS messages to the memory if the phone number of the one of SMS messages is the same as the phone number of the contact entry;
determining whether the one of SMS messages is the last SMS message being compared; and
loading the SMS messages corresponding to the identifier numbers saved in the memory into the mailbox if the one of SMS messages is the last SMS message being compared.

7. The method of claim 6, further comprising cleaning information saved in the mailbox.

8. The method of claim 6, wherein the SMS messages are saved in the memory in a specific order.

9. The method of claim 8, the specific order is depending on the first letters of titles of the SMS messages.

10. The method of claim 8, wherein the identifier numbers are unique for each SMS message.
